(19) United States
(12) Patent Application Publication
(10) Pub. No.: US 2007/0127369 A1
(43) Pub. Date: Jun. 7, 2007

(54) Scheduling with hidden rate request

(75) Inventor: Benoist Sebire, Tokyo (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/587,969

(22) PCT Filed: Feb. 11, 2004
(86) PCT No.: PCT/IB04/00349

§ 371 Date: Sep. 7, 2006

(51) Int. Cl. H04L 12/26; H04Q 7/00

(52) U.S. Cl. 370/229; 370/329

(57) ABSTRACT

The present invention relates to a terminal device and to a scheduling method and device for scheduling data transmission over a plurality of channels in a data network. A predetermined parameter, e.g. a TFC value, indicating a channel capacity in a received data stream of at least one of the plurality of channels is monitored, and a request for change of the maximum channel capacity allocated to the at least one of the plurality of channels is determined, if the value the monitored predetermined parameter falls outside a predetermined allowed range. The terminal device is configured to set a predetermined parameter indicating a channel capacity to a value outside the predetermined allowed range in order to request a change of the maximum channel capacity. Thereby, an explicit capacity request signaling from the data source to the scheduling functionality can be avoided without introducing additional latency, and physical layer resources can be increased for improved data transmission.

### FIELD OF THE INVENTION

The present invention relates to a scheduling device and method of scheduling data transmission over a plurality of channels in a data network, such as a radio access network of a 3^{rd} generation mobile communication system.

### BACKGROUND OF THE INVENTION

Achieving fair bandwidth allocation is an important goal for future wireless networks and has been a topic of intense recent research. In particular, in error-prone wireless links it is impractical to guarantee identical throughputs to each user. As channel conditions vary, lagging flows can catch up to re-normalize each flow's cumulative service. Under a realistic continuous channel module, any user can transmit at any time, yet users will attain different performance levels, e.g. throughput, and require different system resources depending on their current channel condition. Several scheduling algorithms have been designed for continuos channels that provide temporal or throughput fairness guarantees.

A common assumption of existing designs is that only a single user can access the channel at a given time, i.e., time division multiple access (TDMA). However, spread spectrum techniques are increasingly being deployed to allow multiple data users to transmit simultaneously on a relatively small number of separate high-rate channels. In particular, multiple near-orthogonal or orthogonal channels can be created via different frequency hopping patterns or via spreading codes in Code Division Multiple Access (CDMA) systems.

Changing channel conditions are related to three basic phenomena: fast fading on the order of milliseconds, shadow fading on the order of tens of hundreds of milliseconds, and long-time-scale variations due to user mobility.

According to the 3GPP (3^{rd} Generation Partnership Project) specification TR 25.896, an enhanced uplink dedicated channel (EDCH) with higher data rates is proposed for packet data traffic. The enhancements are approached by distributing some of the packet scheduler functionality to the base station devices, or Node Bs in the 3^{rd} generation terminology, to have faster scheduling of bursty non real-time traffic than the conventional Layer 3 (L3) Radio Resource Control (RRC) at the Radio Network Controller (RNC). The idea is that with faster scheduling it is possible to more efficiently share the uplink power resource between packet data users. That is, when packets have been transmitted from one user, the scheduled resource can be made available immediately for another user. This avoids the peaked variability of noise rise, when high data rates are being allocated to users running bursty high data rate applications.

In the current architecture, the packet scheduler is located in the RNC and therefore is limited in its ability to adapt to the instantaneous traffic due to the bandwidth constraints on the RRC signaling interface between the RNC and the terminal device, or user equipment (UE) in the 3^{rd} generation terminology. Hence, to accommodate the variability, the packet scheduler must be conservative in allocating uplink power to take into account the influence of inactive users in the following scheduling period. However, this solution turns out to be spectrally inefficient for high allocated data rates and long release timer values.

For transmission of data, the UE selects a transport format combination (TFC) that suits the amount of data to be transmitted in its Radio Link Control (RLC) buffer, subject to constraints on the maximum transmission power of the UE and the maximum allowed TFC (hereafter referred to as TFCₘₐₓ). The TFC is an authorized combination of currently valid transport formats, i.e. formats offered for the delivery of a transport block set, that can be simultaneously submitted on a transport channel to the UE. Primarily, TFCₘₐₓ is the output of the centralized packet scheduler. The UE can use any TFC up to TFCₘₐₓ and hence this parameter is used as a control variable by which centralized scheduling exerts control on the packet data users.

With EDCH, the Node B or, more general, the base station device takes care of allocating uplink resources. For transmission of data, the UE selects a TFC that suits the amount of data to be transmitted in its RLC (Radio Link Control) buffer, subject to constraints on the maximum transmission power of the UE and TFCₘₐₓ which is proposed to be signalled by the Node B to the UE.

For the implementation of fast centralized scheduling, it is usually required to have an equally fast uplink (UL) handshake mechanism between the UE and the Node B to inform about the instantaneous transmission requirements. However, such signaling information takes up resources, e.g. bandwidth, of the physical layer and leaves less resources for actual data transmission.

Blind detection schemes where the data rate requirements of the UE are blindly detected based on certain observation periods introduce undesirable latency which can be high if the observation time is long, and the estimation is prone to errors, as for any estimation.

### SUMMARY OF THE INVENTION

It is therefore an object of the present invention to provide a scheduling mechanism by means of which explicit signaling between the centralized scheduling functionality and the scheduled data source can be avoided without introducing latency or estimation errors.

This object is achieved by a scheduling device for scheduling data transmission over a plurality of channels in a data network, said device comprising:
monitoring means for monitoring a predetermined parameter indicating a channel capacity in a received data stream of at least one of said plurality of channels; and
scheduling means for determining a request for change of the maximum channel capacity allocated to said at least one of said plurality of channels, if the value of said monitored predetermined parameter falls outside a predetermined allowed range.

Furthermore, the above object is achieved by a scheduling method of scheduling data transmission over a plurality of channels in a data network, said method comprising the steps of:
monitoring a predetermined parameter indicting a channel capacity in a received data stream of at least one of said plurality of channels; and
determining a request for change of the maximum channel capacity allocated to said at least one of said plurality of channels, if the value said monitored predetermined parameter falls outside a predetermined allowed range.

Additionally, the above object is achieved by a terminal device for transmitting data via at least one data channel to a data network, said terminal device being configured to set a predetermined parameter indicating a channel capacity to a value outside a predetermined allowed range, in order to request a change of the maximum channel capacity.

Accordingly, the scheduling functionality or mechanism allocated for example at the Node B monitors capacity requirements of the scheduled data sources based on the value of the received predetermined capacity parameter of their channels, and grants resources according to this value in relation to the allowed range. Thereby, an explicit capacity request signaling from the data source to the scheduling functionality can be avoided and physical layer resources can be increased for improved data transmission. The scheduling mechanism is thus capable of avoiding high variability of uplink noise rise by scheduling US transmissions according to their near instantaneous capacity requirements as signaled by the received parameter values. A correspondence can thereby be achieved between allocated and actually required uplink resources without introducing any latency due to a monitoring period.

The maximum channel capacity may correspond to a maximum allowed data rate. In particular, the maximum allowed data rate may be set by a maximum transport format combination. This transport format combination is defined as the combination of currently valid transport formats on all transport channels of a mobile terminal or user equipment, i.e. containing one transport format from each transport channel. The transport format is defined as a format offered by the physical protocol layer L1 to the Medium Access Control (MAC) protocol for the delivery of a transport block set during a transmission time interval (TTI) on a transport channel. The transport format comprises a dynamic part and a semi-static part. The transport block set is defined as a set of transport blocks passed to L1 from MAC at the same time instance using the same transport channel. An equivalent term for transport block set is MAC packet data unit (PDU) set.

The monitoring means may be configured to derive the value of the predetermined parameter by decoding a transport format combination indicator (TFCI) information provided in the received data stream. The TFCI information is a representation of the current transport format combination.

The scheduling means may be configured to check the available resources and to reject the determined request in response to the checking result. As an alternative decision, the scheduling means may increase the maximum channel capacity to a value smaller than the value of the monitored predetermined parameter in response to the checking result, if the request has been determined. As another alternative decision, the scheduling means may check the available resources and increase the maximum channel capacity to the value of the monitored predetermined parameter in response to the checking result, if the request has been determined. In the first two cases, the scheduling means may be configured to repeat the checking at a predetermined timing.

The plurality of channels may be dedicated uplink channels of a radio access network. The scheduling device may be a base station device, e.g., a Node B device.

Furthermore, the terminal device may be a cellular terminal device and/or may be configured to select the value of the predetermined parameter from a predetermined temporary range comprising values higher than the allowed range. The use of said value of the temporary range may be restricted to a predetermined time period. Additionally, the use can be repeated at a predetermined timing. The temporary range may comprise at least one value.

The plurality of channels may be dedicated uplink channels of a radio access network, such as the UMTS Terrestrial Radio Access Network (UTRAN). Then, the scheduling device may be a base station device, e.g. a Node B, or a radio network controller device, e.g. an RNC.

### BRIEF DESCRIPTION OF THE DRAWINGS

In the following, the present invention will be described on the basis of a preferred embodiment with reference to the accompanying drawings in which:

FIG. 1 shows a schematic diagram of network architecture in which the present invention can be implemented;

FIG. 2 shows a schematic diagram of a physical channel structure for a data transmission in which the present invention can be applied;

FIG. 3 shows a table indicating a TFCS of a UE with predetermined TFC ranges according to the preferred embodiment;

FIG. 4 shows a diagram indicating transmitted power over time in case of a granted capacity request according to the preferred embodiment;

FIG. 5 shows a diagram indicating transmitted power over time in case of a partially granted capacity request according to the preferred embodiment;

FIG. 6 shows a diagram indicating transmitted power over time in case of a rejected capacity request according to the preferred embodiment;

FIG. 7 shows a schematic block diagram of a scheduling functionality according to the preferred embodiment; and

FIG. 8 shows a schematic flow diagram of a scheduling procedure according to the preferred embodiment.

### DESCRIPTION OF THE PREFERRED EMBODIMENT

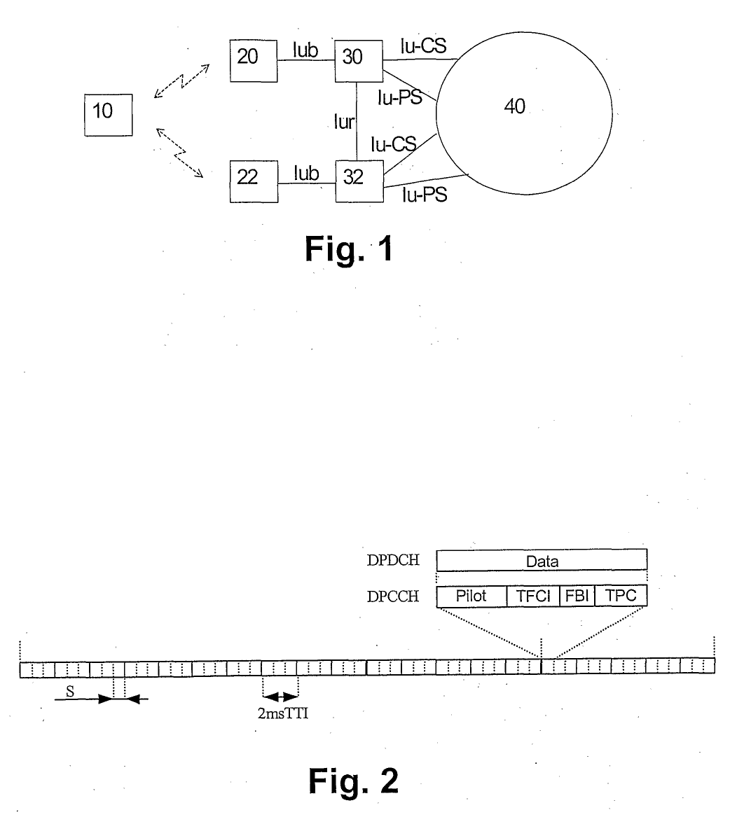

The preferred embodiment will now be described on the basis of a 3^{rd} generation Wideband CDMA (WCDMA) radio access network architecture as shown in FIG. 1.

3^{rd} generation mobile systems like UMTS are designed to provide a wide range of services and applications to the mobile user. The support of higher user bit rates is most likely the best known feature of UMTS. Furthermore, provisioning of appropriate quality of service (QoS) will be one of the key success factors for UMTS. A mobile user gets access to UMTS through the WCDMA-based UTRAN. A base station or Node B 20, 22 terminates the L1 air interface and forwards the uplink traffic from a UE 10 to an RNC 30, 32. The RNCs 30, 32 are responsible for radio resource management (RRM) and control all radio resources within their part of the UTRAN. The RNCs 30, 32 are the key interface partners for the UE10 and constitute the interface entity towards a core network 40, e.g. via a UMTS Mobile Switching Center or a Serving GPRS (General Packet Radio Services) Support Node (SGSN). Within the UTRAN, Asynchronous Transfer Mode (ATM) is used as the main transport technology for terrestrial interconnection of the UTRAN nodes, i.e. RNCs and Node Bs.

In the simplified sample architecture shown in FIG. 1, the UE10 is connected via an air interface to a first Node B 20 and/or a second Node B 22. The first and second Node Bs 20, 22 are connected via respective lub interfaces to first and second RNCs 30, 32 which are connected to each other via a lur interface. The Node Bs 20, 22 are logical nodes responsible for radio transmission and reception in one or more cells to/from the UE 10 and terminate the lub interface towards the respective RNC 30, 32. The RNCs 30, 32 provide connections to the core network 40 for circuit switched traffic via a lu-CS interface and for packet switched traffic via a lu-PS interface. It should be noted that in a typical case many Node Bs are connected to the same RNC.

FIG. 2 shows a schematic diagram of a physical channel structure for one dedicated physical data channel (DPDCH). In the WCDMA system, each normal radio frame, the length of which is 10 ms, consists of 15 slots S. In the uplink direction, the data and control part are IQ-multiplex, i.e., the user data of the DPDCH is transmitted using the I-branch and the control data of the dedicated physical control channel (DPCCH) is transmitted using the Q-branch. Both branches are BPSK (Binary Phase Shift Keying) modulated. FIG. 2 shows both DPDCH and DPCCH in parallel. Each DPCCH slot comprises two Transport Format Combination Indicator (TFCI) bits which together with TFCI bits from other slots of the frame represent the current TFC, i.e. the combination of currently valid transport formats on all transport channels of the concerned UE 10. In particular, the TFC contains one transport format for each transport channel. Furthermore, each DPCCH time slot of the frame structure of the time multiplexed transmission signal between the UE 10 and the Node Bs 20, 22 comprises a transmit power control command (TPC) field used for power control function as well as a pilot field for signaling a pilot information. Moreover, a feedback information (FBI) field is provided for feedback signaling. The uplink DPDCH field only contains data bits, typically from many transport channels. Further details concerning this WCDMA frame structure are described in the 3^{rd} Generation Partnership Project (3GPP) specifications TS 25.211 and TS 25.212.

Furthermore, according to the structure of FIG. 2, each transmission time interval (TTI) which defines the transmission time for a transport block set has a length of 2 ms, for example, and thus corresponds to three time slots S. This shorter TTI is used for the enhanced uplink dedicated channel (EDCH) for increased cell and user throughput and shorter delay. Such a shorter TTI can be introduced by having it on a separate code channel, i.e. by code multiplexing it, or by incorporating it into the conventional time multiplexing scheme at radio frame level. It is to be noted here that the scheduling mechanism is not necessarily tied to a 2 ms TTI, any other TTI value may be used.

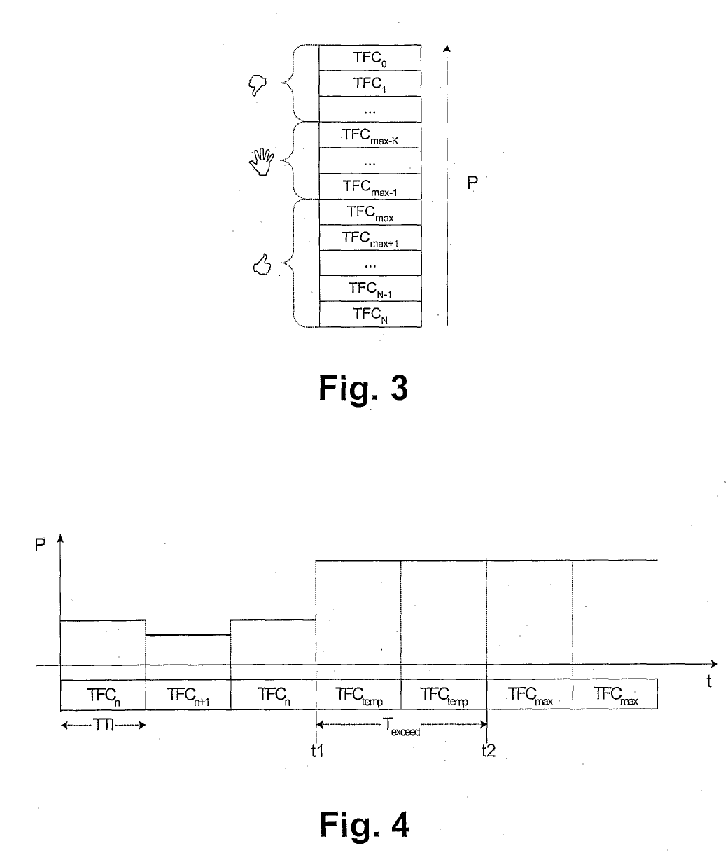

FIG. 3 shows a table of a transport format combination set (TFCS) of the UE 10, where the TFCs are ordered according to the required transmission power. The TFCS is defined as a set of TFCs on a CCTrCH (Coded Composite Transport Channel) and is produced by a proprietary algorithm in the serving RNC. The selection of TFCs can be regarded as the fast part of the radio resource control dedicated to MAC (Medium Access Control) protocol. Thereby, the bit rate can be changed very quickly with no need for higher layer signalling. In FIG. 3, the TFCS contains N TFCs. TFCₘₐₓ is signalled by the Node B to the UE.

According to the present invention, a rate request used for adapting the maximum allowable channel capacity e.g. in terms of maximum transmission power is sort of “hidden” or indirectly signaled by using a capacity parameter value outside an allowed range. It is to be noted here that any suitable parameter of limited allowed range can be used for conveying such a hidden request. In the preferred embodiment, it is suggested to use the TFC value signaled e.g. in the DPCCH by means of the TFCI parameter.

To achieve this, as an example, the TFCS in FIG. 3 can be divided into three ranges comprising a forbidden range TFC₀ to TFC_{max-K-1}, a temporary range TFC_{max-K} to TFCₘₐₓ₋₁, and an allowable range TFCₘₐₓ to TFC_{N}. When the transmission requirements of the UE 10 increase, i.e. when the UE needs to transmit data with a TFC that is higher than TFCₘₐₓ, it is allowed for a short period of time (hereafter referred to as T_{exceed}) to use a temporary TFCₜₑₘₚ within the temporary range, i.e. between TFCₘₐₓ₋₁ and TFC_{max-K}. The value of K can either be a predetermined fixed value, for instance 1, or signaled by the Radio Access Network (RAN), e.g. the UTRAN, to the UE 10. Similarly, T_{exceed} can either be a predetermined fixed time, for instance a few TTIs, or can be signaled by the RAN to the UE 10. As an example, T_{exceed} could be one TTI.

As a part of the decoding process when receiving data from the UE 10, the Node B 20, 22 can determine if a temporary TFCₜₑₘₚ higher than TFCₘₐₓ was used and therefore knows when the UE 10 needs a higher TFCₘₐₓ, i.e. when the transmission requirements of the UE 10 increase. Based on available resources and other possible criteria, the Node B 20, 22 may grant what was requested by signalling to the UE 10 a new TFCₘₐₓ=TFCₜₑₘₚ.

FIG. 4 shows a diagram indicating transmitted power over time in case of a granted capacity request. As can be gathered from this diagram, the temporarily increased TFCₜₑₘₚ which started at a timing t1 until the end of the allowed time period T_{exceed} was allocated by the scheduling function at the respective Node B 20, 22 as new TFCₘₐₓ after timing t2. Here, the allowed time period T_{exceed} corresponds to two TTIs.

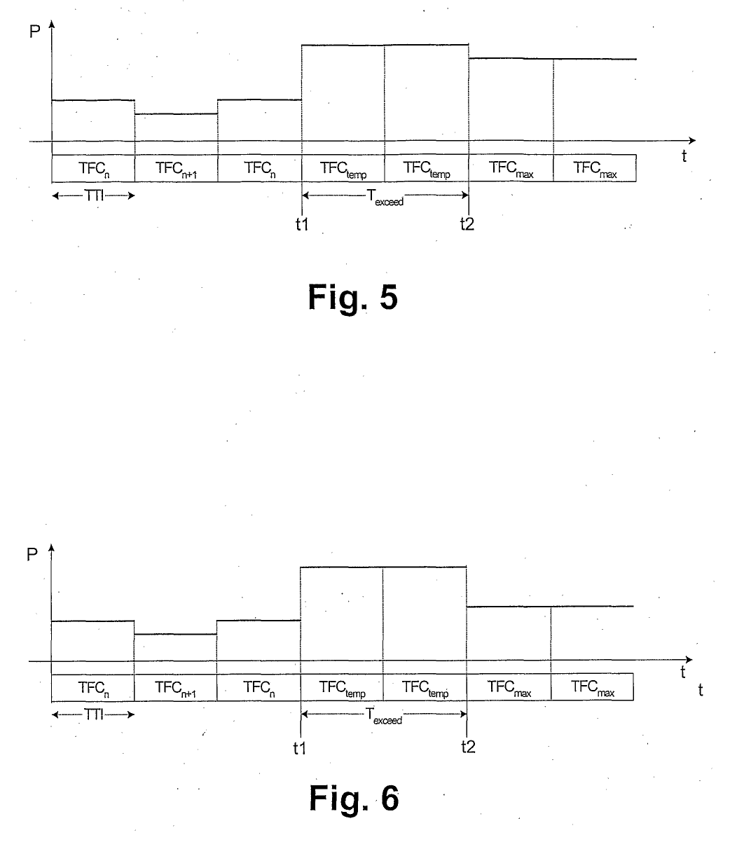

FIG. 5 shows a diagram indicating transmitted power over time in case of a partially granted capacity request. If K>1, i.e. the temporary range consists of more than one TFC, the request for increased TFCₘₐₓ can be partly granted by signalling a new TFCₘₐₓε[TFCₜₑₘₚ₊₁ . . . TFCₘₐₓ₋₁] to the UE 10. In FIG. 5, the temporary TFCₜₑₘₚ signaled by the UE 10 using the TFCI parameter was higher than the granted increased TFCₘₐₓ allocated by the scheduling function at the respective Node B 20, 22.

FIG. 6 shows a diagram indicating transmitted power over time in case of a rejected capacity request. Here, the request is denied by the scheduling function and the prevailing TFCₘₐₓ is kept as it is. Therefore, in FIG. 6, the value of TFCₘₐₓ used after the timing t2 corresponds to the value of TFCₘₐₓ in the TFCS of the UE 10 before the timing t1.

In the last two cases of FIGS. 5 and 6, several subsequent behaviours of the UE 10 are possible. For example, the UE 10 may not be allowed to transmit data with a TFC higher than TFCₘₐₓ. Since the respective Node B 20, 22 is already aware of the previous request, it can always allow higher TFC if it is possible. As an alternative, the UE 10 may be periodically allowed to poll for higher TFC by using TFCₜₑₘₚ as before.

The allocation of the available resources by the scheduling device, which may be the respective Node B 20, 22, is based on the above described selection of the signaled TFC value by the UE 10. This means, that the use of a temporary (forbidden) TFCₜₑₘₚ is decisive for the future scheduled capacity allocation. Thereby, high variability of uplink noise rise can be avoided by scheduling UE transmissions according to their instantaneous transmission capacity requirements and thereby achieve correspondence between allocated and actually required uplink resources without any explicit uplink signaling requirements. This correspondence between allocated and used capacity is also advantageous for cell capacity, as it helps to free the maximum amount of resources packet data use.

In particular, the Node Bs 20, 22 continuously monitor the used TFC values of the UEs, which are known to the Node Bs 20, 22 e.g. from decoding the TFCI information in the uplink data frames. Based on the monitored TFCs, the scheduling function at the Node Bs 20, 22 grants resources, i.e. allocates a new maximum TFC.

If the TFC value is in the temporary range, i.e. the UE 10 requires a higher TFCₘₐₓ, the Node Bs 20, 22 may schedule the respective UE for a higher TFCₘₐₓ. Of course, the scheduling mechanism may as well be adapted to reduce the TFCₘₐₓ to a lower value, e.g. if the scheduled TFCₘₐₓ is not used for a predetermined time period or if the signaled TFC value is below a predetermined lower TFC threshold or within a second temporary lower range (not shown in FIG. 3).

However, it is noted that the exact action taking by the scheduling function may additionally depend on other parameters, such as the scheduling policy, the current cell load, QoS descriptive parameters such as an Allocation Retention Priority (ARP) for the user, the traffic class (TC), the traffic handling priority (THP). Furthermore, the scheduling decision may depend on minimum and maximum data rate allocations and/or uplink radio link conditions, e.g. estimated path loss, such that TFCₘₐₓ is scheduled only when the channel conditions are favorable to thereby avoid unnecessary retransmissions and provide better power efficiency of the UE. The use of such additional information in scheduling may include the downlink (DL) power control (PC) commands, since they indicate whether channel quality improves or degrades.

For simplification, all other issues impacting the value of the granted TFCₘₐₓ are disregarded in the following description, and the scheduling decision is assumed to be only based on the TFC value signaled by the UE 10. Hence, the granted TFCₘₐₓ is adapted to the individual capacity demand of the UE10.

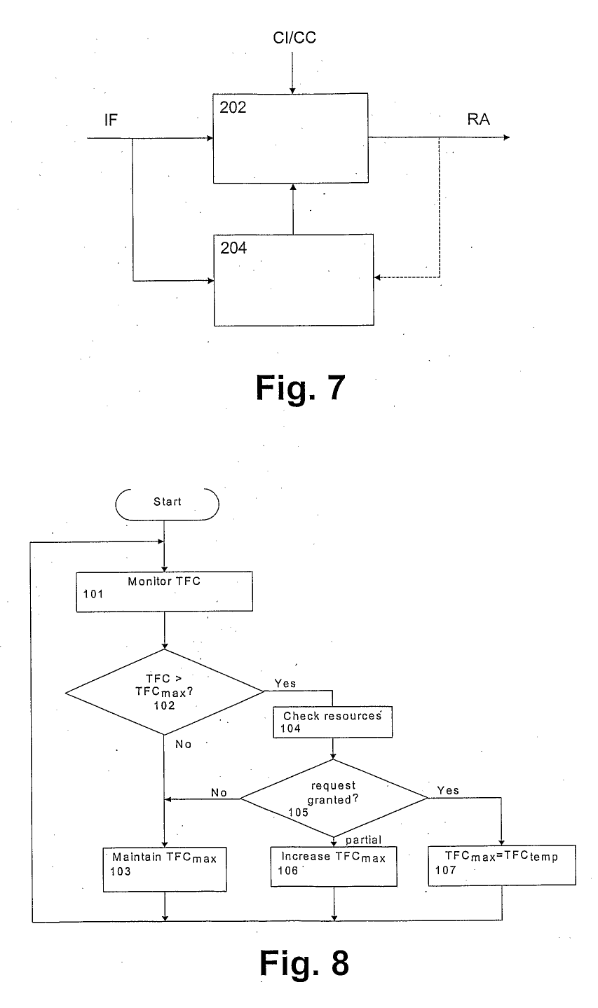

FIG. 7 shows a schematic block diagram of a scheduling functionality which may be implemented at each of the Node Bs 20, 22 in FIG. 1. A scheduling decision making block or scheduling block 202 makes scheduling decisions based on the received TFC value (e.g., as indicated by the TFCI parameter) which is monitored by a corresponding TFC monitoring block 204. Additionally, the scheduling decision may be based on other general channel information CI or channel conditions CC which however are neglected in the description of the preferred embodiment, as already mentioned.

The scheduling block 202 receives an incoming data stream or data flow IF and outputs a corresponding scheduling decision or resource allocation RA, which may represent a set of maximum data rates or TFCₘₐₓ for simultaneous transmission of multiple users. This scheduling decision is output to the physical layer which transmits packets accordingly. This may be achieved by some kind of explicit signaling, e.g. by defining a new signaling channel, stealing bits by puncturing, or any other suitable signaling option.

However, adapting to the individual requests of the UE 10 may lead to short-term deviations from ideal fairness. Therefore, to enable service compensation at a later and more opportune time to underserviced flows, the scheduling decision may optionally be fed back to the utilization monitoring block 204, as indicated by the dotted arrow in FIG. 7. Then, the utilization monitoring block 204 may update its output values in such a manner that the output of the scheduling block 202 will satisfy the fairness criteria on a larger time scale. As an alternative, this long-term fairness control may be implemented in the scheduling block 202 itself.

The scheduling and utilization monitoring blocks 202 and 204 may be implemented as concrete hardware structures or alternatively as software routines controlling a corresponding processing unit e.g. for MAC layer processing at the Node Bs 20, 22.

FIG. 8 shows a schematic flow diagram of a specific example of a scheduling procedure according to the preferred embodiment. Initially, in step 101, the TFC value as signaled by the UE 10 e.g. in the DPCCH is monitored. Then, in step 102 the value of the signaled TFC is compared to the allowable range, e.g. TFCₘₐₓ to TFC_{N} in order to decide whether TFC>TFCₘₐₓ. If the received TFC value is within the allowable range, i.e. TFC≦TFCₘₐₓ, the procedure branches to step 103 and the current or prevailing TFCₘₐₓ is maintained. On the other hand, if the received TFC value is not within the allowable range due to the fact that the UE 10 has signaled a TFCₜₑₘₚ selected from the temporary range, the procedure proceeds to step 104 and the scheduling block 202 of FIG. 7 checks the available capacity resources. Based on this checking operation, the scheduling block 202 decides in step 105 whether to grant, partially grant or reject the request. If it decides to fully grant the request, the procedure branches to step 107 and the new TFCₘₐₓ is set to the temporary TFCₜₑₘₚ. On the other hand, if it is decided in step 105 that the request is only partially granted, the procedure branches to step 106 and a scheduling decision is issued which increases TFCₘₐₓ to a value smaller than TFCₜₑₘₚ but still higher than the former TFCₘₐₓ. If it is decided to reject the request, the procedure branches to step 103 and the prevailing TFCₘₐₓ is maintained. Then, the procedure may loop back to step 101 so as to continuously adapt the scheduled maximum capacity to the capacity demand of the respective user or UE.

As already mentioned, the scheduling functionality according to FIGS. 7 and 8 may be implemented in the MAC layer functionality of the Node Bs 20, 22. There may be other factors as well, which determine the TFCₘₐₓ that the scheduling functionality at the Node Bs 20, 22 grants to a certain UE.

Thus, a fast enhanced uplink channel packet scheduling can be provided, where the scheduling device makes scheduling decisions without additional uplink signaling and without latency. This provides the advantage that less signaling overhead is required in the uplink direction and that the UE requirements are implemented without significant delay or latency. Hence fast ramp functions can be allowed for capacity scheduling.

It is to be noted that the present invention is not restricted to the above preferred embodiment but can be implemented in any multi-channel data transmission to thereby provide a capacity allocation with improved throughput and reduced signaling requirements and delay. In particular, the invention is not restricted to an uplink direction of a cellular network and can be implemented in any data transmission link. The “hidden” channel capacity request may be signaled by other parameters and the range of parameter values, e.g. TFCS, may be divided in other or even more ranges to further specify the content of the hidden request. Any parameter suitable to control an allocated channel capacity can be used. The preferred embodiment may thus vary within the scope of the attached claims.

1. A scheduling device for scheduling data transmission over a plurality of channels in a data network, said device comprising:
a monitoring unit configured to monitor a predetermined parameter indicating a channel capacity in a received data stream of at least one of said plurality of channels; and
a scheduling unit configured to determine a request for change of a maximum channel capacity allocated to said at least one of said plurality of channels, if a value of said monitored predetermined parameter falls outside a predetermined allowed range.

2. A device according to claim 1, wherein said maximum channel capacity corresponds to a maximum allowed data rate.

3. A device according to claim 2, wherein said maximum allowed data rate is set by a maximum transport format combination.

4. A device according to claim 1, wherein said monitoring unit is configured to derive said value of said predetermined parameter by decoding a transport format combination indication information provided in said received data stream.

5. A device according to unit, wherein said scheduling unit is configured to check available resources and to reject said determined request in response to the checking result.

6. A device according to claim 1, wherein said scheduling unit is configured to check available resources and to increase said maximum channel capacity to a value smaller than said value of said monitored predetermined parameter in response to the checking result, if said request has been determined.

7. A device according to claim 1, wherein said scheduling unit is configured to check available resources and to increase said maximum channel capacity to said value of said monitored predetermined parameter in response to the checking result, if said request has been determined.

8. A device according to claim 5, wherein said scheduling unit is configured to repeat said checking at a predetermined timing.

9. A device according claim 1, wherein said plurality of channels are dedicated uplink channels of a radio access network.

10. A device according to claim 1, wherein said scheduling unit comprises a base station device.

11. A terminal device for transmitting data via at least one data channel to a data network, said terminal device being configured to set a predetermined parameter indicating a channel capacity to a value outside a predetermined allowed range, in order to request a change of the maximum channel capacity.

12. A terminal device according to claim 11, wherein said value is selected from a predetermined temporary range comprising values higher than said allowed range.

13. A terminal device according to claim 12, wherein the use of said value of said temporary range is restricted to a predetermined time period.

14. A terminal device according to claim 13, wherein said use of said value of said temporary range can be repeated at a predetermined timing.

15. A terminal device according to claim 12 to 14, wherein said temporary range comprises at least one value.

16. A terminal device according to claim 11, wherein said predetermined parameter indicates a transport format combination.

17. A terminal device according to claim 11, wherein said terminal device is a cellular terminal device.

18. A scheduling method of scheduling data transmission over a plurality of channels in a data network, said method comprising:
a) monitoring a predetermined parameter indicating a channel capacity in a received data stream of at least one of said plurality of channels; and
b) determining a request for change of the maximum channel capacity allocated to said at least one of said plurality of channels, if a value of said monitored predetermined parameter falls outside a predetermined allowed range.

19. A method according to claim 18, wherein said maximum channel capacity corresponds to a maximum allowed data rate.

20. A method according to claim 19, further comprising of setting said maximum allowed data rate by a maximum allowed transport format combination.

21. A method according to claim 20, wherein said monitoring comprises deriving said value of said predetermined parameter by decoding a transport format combination indication information provided in said received data stream.

22. A method according to claim 18, further comprising checking available resources and rejecting said determined request in response to the result of said checking.

23. A method according to claim 18, further comprising checking the available resources and increasing said maximum channel capacity to a value smaller than said value of said monitored predetermined parameter in response to the result of said checking, if said request has been determined.

24. A method according to claim 18, further comprising checking the available resources and increasing said maximum channel capacity to said value of said monitored predetermined parameter in response to the result of said checking, if said request has been determined.

25. A method according to claim 22, further comprising repeating said checking at a predetermined timing.

26. A system for scheduling data transmission over a plurality of channels in a data network, said system comprising:
a terminal device for transmitting data via at least one data channel to a data network, said terminal device being configured to set a predetermined parameter indicating a channel capacity to a value outside a predetermined allowed range, in order to request a change of the maximum channel capacity; and
a scheduling device for scheduling data transmission over a plurality of channels in the data network, a scheduling device including a monitoring unit configured to monitor the predetermined parameter in a received data stream of the at least one data channel, and a scheduling unit configured to determine a request for change of the maximum channel capacity, if a value of the monitored predetermined parameter falls outside a predetermined allowed range.

27. A scheduling device for scheduling data transmission over a plurality of channels in a data network, said scheduling device comprising:
monitoring means for monitoring a predetermined parameter indicating a channel capacity in a received data stream of at least one of the plurality of channels; and
scheduling means for determining a request for change of a maximum channel capacity allocated to the at least one of the plurality of channels, if a value of the monitored parameter falls outside of a predetermined allowed range.
